(19) United States
(12) Patent Application Publication
(10) Pub. No.: US 2021/0074113 A1
(43) Pub. Date: Mar. 11, 2021

(54) AUTOMATIC PRODUCT DISPENSING MACHINE

(71) Applicants: SANDEN RETAIL SYSTEMS CORPORATION, Isesaki-shi, Gunma (JP); THE COCA-COLA COMPANY, Atlanta, GA (US)

(72) Inventor: Yugo UEHATA, Isesaki-shi, Gunma (JP)

(21) Appl. No.: 16/071,811

(22) PCT Filed: Jul. 19, 2016
(86) PCT No.: PCT/JP2016/071182

§ 371 Date: Sep. 11, 2018

(30) Foreign Application Priority Data
Jan. 21, 2016 (JP) 2016-010133

(51) Int. Cl. G07F 7/08; G07F 7/12

(52) U.S. Cl. CPC G07F 7/084; G07F 7/12

(57) ABSTRACT

An automatic product dispensing machine (100) according to an aspect of the present invention comprises a product storage device (4), a control unit (30) for controlling product dispensing operation of the product storage device (4), a reading unit (12) for reading information including at least a dispensing permission indication of a product from a product claim card (recording medium) (C) that records the information, and a collecting part (20) for collecting and containing product claim cards (C). In accordance with the information read by the reading unit (12), the control unit (30) outputs a dispensing permission command to the product storage device (4) for permitting dispensing of the product.

### TECHNICAL FIELD

The present invention relates to an automatic product dispensing machine for storing therein a plurality of products and sequentially dispensing the stored products so as to deliver each product to a user.

### BACKGROUND ART

As an example of an apparatus for dispensing a product to a user, a vending machine as disclosed in Patent Document 1 is commonly known. In a vending machine of this type, multiple items of products, each packaged in an appropriate container, such as bottled beverages, are stored in the product storage chamber. When the user inputs money such as coins into the vending machine of this type and presses an item selection button, and it is determined that the input money is equal to or above the price of the selected item, the vending machine delivers a product of the selected item to the user by dispensing the product from the product storage chamber to the product delivery portion.

As described above, the vending machine of this type requires the user to perform at least operations of inputting money such as coins into the machine and pressing an item selection button in order to receive a product.

### REFERENCE DOCUMENT LIST

### Patent Document

Patent Document 1: JP 2011-170586 A

### SUMMARY OF THE INVENTION

### Problem to be Solved by the Invention

As described above, a vending machine of this type requires the user to perform a series of operations such as inputting money into the machine, pressing an item selection button, and, if necessary, receiving change. Since a user may be annoyed by such a series of many operations, there is a demand to improve this type of vending machine.

The present invention has been made in view of the above circumstances, and an object of the present invention is to provide an automatic product dispensing machine that allows the user to easily receive a product by performing fewer operations on the machine.

### Means for Solving the Problems

According to an aspect of the present invention, an automatic product dispensing machine comprises a product storage device for storing therein products and sequentially dispensing the stored products, and a control unit for controlling product dispensing operation of the product storage device. The automatic product dispensing machine further comprises a reading unit for reading information including at least a dispensing permission indication of one of the products from a recording medium that records the information; and a collecting part for collecting and containing the recording medium after the reading unit has read the information. In accordance with the information read by the reading unit, the control unit outputs a dispensing permission command to the product storage device for permitting dispensing of the product.

### Effects of the Invention

In the automatic product dispensing machine according to the above aspect of the present invention, the reading unit reads information including at least a dispensing permission indication of one of the products from a recording medium that records the information, the collecting part collects the recording medium after the reading unit has read the information, and the control unit outputs a dispensing permission command to the product storage device for permitting dispensing the product in accordance with the information read by the reading unit. This allows the user to receive the product dispensed by the product storage device simply by having the reading unit read the information of the recording medium. In addition, since the recording medium is collected by the collecting part rather than being returned to the user, the user does not feel annoyed by the manner of handling and managing the recording medium after use. As described above, instead of requiring conventional operations and the like such as inputting money such as coins into the machine, pressing an item selection button, and receiving change, the automatic product dispensing machine according to the above aspect of the present invention only requires the user to perform a simple operation of having the machine read the information of the recording medium in order to receive a product.

As described above, the present invention provides an automatic product dispensing machine that allows the user to easily receive a product by performing fewer operations on the machine.

### BRIEF DESCRIPTION OF THE DRAWINGS

FIG. 1 is a front view of an automatic product dispensing machine according to an embodiment of the present invention.

FIG. 2 is a perspective view of the automatic product dispensing machine of FIG. 1 with its outer door open.

FIG. 3 is a schematic block diagram of the automatic product dispensing machine.

FIG. 4 is a cross-sectional view of a substantial part of the automatic product dispensing machine as viewed in the direction of arrow A-A of FIG. 1.

FIG. 5 is a schematic diagram for illustrating the operation of the automatic product dispensing machine.

### MODE FOR CARRYING OUT THE INVENTION

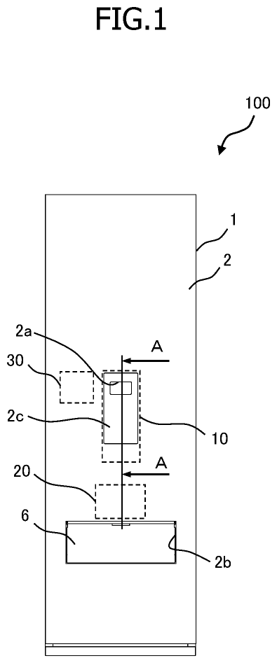

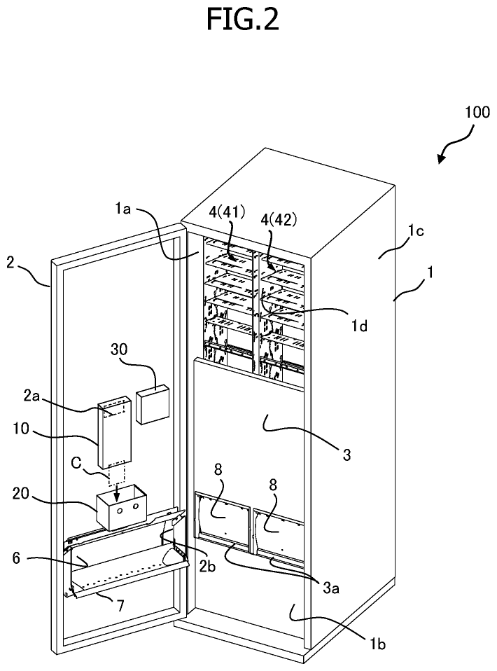

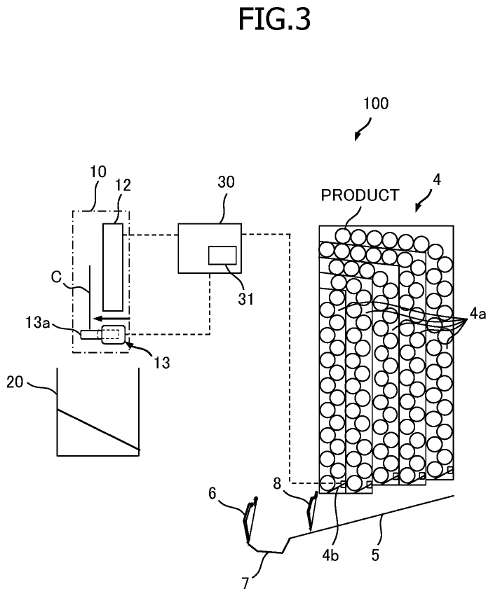

The present invention will be described below with reference to the accompanying drawings. FIG. 1 is a front view (as viewed from a user) of an automatic product dispensing machine 100 according to an embodiment of the present invention. FIG. 2 is a perspective view of the automatic product dispensing machine 100 with an outer door 2 open. The outer door 2 will be described later. FIG. 3 is a schematic block diagram of the automatic product dispensing machine 100, for schematically illustrating the operation of the automatic product dispensing machine 100. The automatic product dispensing machine 100 is configured to cool and store, as products, bottled beverages (beverages each packaged in a PET bottle, in this embodiment) therein and to dispense a product according to a user's request. The automatic product dispensing machine 100 includes an automatic product dispensing machine body 1 having an open front face, the outer door 2 for opening and closing the front face of the automatic product dispensing machine body 1, and an inner door 3 for opening and closing the front face of a product storage chamber 1a, which will be described later. In this embodiment, the automatic product dispensing machine 100 is installed in a store such as a convenience store, as an example.

This automatic product dispensing machine 100 is configured to dispense a product according to the user's request in exchange for a product claim card C rather than in exchange for coins, bills, or electronic money. The product claim card C is a recording medium that previously records information including at least a dispensing permission indication for permitting dispensing of the product. In this embodiment, the product claim card C is an IC card incorporating an IC chip that records the above information, as an example. What information is recorded in this product claim card C, specifically, and how the user obtains this product claim card C, will be described in detail later.

The automatic product dispensing machine body 1 is partitioned into the product storage chamber la for storing therein products and a machine compartment 1b that houses part of a cooling device for cooling the products. The machine compartment 1b is located below the product storage chamber 1a. The automatic product dispensing machine body 1 has an open front face and heat-insulating walls 1c which enclose the product storage chamber 1a.

The product storage chamber 1a has a heat-insulated structure in which the top, rear, bottom, left, and right side faces are defined by the heat-insulating walls 1c and the front face opens. Product storage devices 4 are disposed in the product storage chamber 1a. A product shooter 5 (see FIG. 3) is disposed below the product storage devices 4. The product shooter 5, which is a flat plate member having numerous air-passing holes, is disposed to be inclined downward toward the front face of the automatic product dispensing machine 100. Also, part of the cooling device is provided in a lower portion of the product storage chamber 1a. In this embodiment, the product storage chamber 1a is partitioned into two compartments by a partition wall 1d extending vertically along a central portion in the lateral width direction of the product storage chamber 1a. The product storage devices 4 are disposed, one each, in these two compartments. The product storage devices 4 will be described in detail later.

The outer door 2 opens and closes the front face of the automatic product dispensing machine body 1. One end of the outer door 2 in its width direction is pivotally supported by the automatic product dispensing machine body 1. The front surface of the outer door 2 has an insertion slot 2a through which the user inserts the product claim card C, and a delivery port 2b from which the user receives a product. Furthermore, on the front surface of the outer door 2, a resin decorative plate 2c is mounted so as to surround the insertion slot 2a. A card reader unit 10 for reading information recorded in the product claim card C is mounted on a portion, corresponding to insertion slot 2a, of the back surface of the outer door 2. An outer-door flap 6 is attached to the upper end of the delivery port 2b so as to be pivotable in the front-back direction. The outer-door flap 6 allows the opening and closing of the delivery port 2b. A product receiving portion 7 for receiving products dispensed from the insides of the product storage devices 4 is mounted on a portion, corresponding to the delivery port 2b, of the back surface of the outer door 2. In addition, the back surface of the outer door 2 is further provided with a collecting part 20 for collecting the product claim card C and a control unit 30 for controlling the operation of the cooling device and the like. The card reader unit 10, the collecting part 20, and the control unit 30 will be described in detail later.

The inner door 3 opens and closes the front face of the product storage chamber 1a in the automatic product dispensing machine body 1. The inner door 3 contains a heat-insulating material. A plurality of (two in the drawings) product dispensing openings 3a communicating with the product storage chamber 1a and the delivery port 2b are formed in a lower portion of the heat-insulating inner door 3 so as to be arranged side by side in the width direction (right-left direction). An inner-door flap 8 is attached to the upper end of each product dispensing opening 3a so as to be pivotable in the front-back direction. The inner-door flaps 8 allow the opening and closing of the product dispensing openings 3a.

Each product storage device 4 is adapted to store therein a plurality of products and to sequentially dispense the products. In this embodiment, the product storage device 4 is capable of storing multiple items of products therein. Furthermore, in this embodiment, the product storage devices 4 are disposed, one each, in the compartments into which the product storage chamber 1a is partitioned by the partition wall 1d. Each of these two product storage devices 4 has a plurality of (five, herein) product storage columns 4a arranged side by side in the front-back direction. Each product storage column 4a is configured to store therein a plurality of products (bottled beverages) of the same item so that the products are vertically stacked one on another and to dispense the products sequentially from a product positioned at the lowest. Each product storage device 4 has a so-called serpentine arrangement. In the product storage device 4, the products inserted from the product input port at the upper end of each product storage column 4a are vertically stacked in the serpentine product path in the product storage column 4a. Product dispensing mechanisms 4b are provided to the lower end of each product storage device 4, and allow the product storage device 4 to drop and dispense the products one by one to the product shooter 5 sequentially from a product positioned at the lowest.

In this embodiment, each of the product storage devices 4 (the left one in FIG. 2 will be referred to as “first storage device 41”, and the right one in FIG. 2 will be referred to as “second storage device 42”) is capable of storing five items of products therein. Thus, the product storage chamber 1a is capable of storing ten items of products in total. However, in this embodiment, the same items are stored in the same manner in the product storage devices 4 (41, 42), as an example. That is, the five items stored in the first storage device 41 are the same as the five items stored in the second storage device 42, and each item of products are stored in the product storage columns 4a that are located at the same position in the front-back direction. A common column number CN is assigned to each two product storage columns 4a that are located at the same position in the front-back direction. For example, the column number CN of the front-most product storage column 4a in the first storage device 41 is the same as the column number CN of the front-most product storage column 4a in the second storage device 42. The column numbers CN of 1, 2, 3, 4, and 5 are assigned to the product storage columns 4a in the ascending order from the front-most product storage columns 4a to the back-most product storage columns 4a.

In this embodiment, each of the compartments in the product storage chamber la is configured to function as a supercooling compartment. Specifically, the interior of each compartment is cooled by the cooling device (not shown) so that the products stored in the corresponding product storage device 4 are cooled in a supercooled state. To achieve this, the control unit 30 controls the operation of the cooling device so that the temperatures in the compartments are maintained at a preset temperature that allows the products therein to be cooled and maintained in the supercooled state.

Here, the preset temperature is equal to or below the freezing point of the bottled beverages, which are stored as the products, and may be around −5° C. (−2° C. to −8° C.), for example. This preset temperature is lower and has a narrower (more limited) allowable range than a preset temperature for normal cold beverages. The commercial values of these supercooled bottled beverages lie in having been maintained in the supercooled state for a predetermined time. However, for example, even while the beverages are stored in the supercooled state in the first storage device 41 and second storage device 42 in the compartments, if either of the first storage device 41 and second storage device 42 is restocked with room-temperature products, the temperature changes in the compartment including this restocked storage device. This may reduce the commercial values of the products in this compartment.

To avoid this, in this embodiment, one of the product storage devices 4 (41, 42) is set as a dispensing-activated device which is ready to dispense the products, and the other is set as an under-preparation device which is forced to stop dispensing the products. In addition, the dispensing-activated device setting and under-preparation device setting of the product storage devices 4 (41, 42) may be switched with each other at predetermined time intervals. For example, assume here that the products are stored in the supercooled state both in the product storage devices 4 (41, 42), and that the first storage device 41 is set as the dispensing-activated device and the second storage device 42 is set as the under-preparation device. In this case, after the first storage device 41 sequentially dispenses the products for a predetermined time, the first storage device 41 is switched to the under-preparation device setting and the second storage device 42 is switched to the dispensing-activated device setting. Then, the operator or the like restocks the first storage device 41, which is newly set as the under-preparation device, with products. This ensures that the products in the second storage device 42, which is newly set as the dispensing-activated device, do not have insufficient commercial values. Furthermore, as early as immediately after this switching, the second storage device 42 is ready to dispense supercooled beverages in response to users' requests. Thus, the loss of product dispensing opportunities will be avoided. Furthermore, the products added in the first storage device 41, which is newly set as the under-preparation device, will have acquired sufficient commercial values as supercooled beverages by the time of the next switching. In this way, the automatic product dispensing machine 100 according to this embodiment is capable of continuously dispensing supercooled beverages to users.

Here, what information is recorded in the product claim card C, and how the user obtains this product claim card C will be described.

The information recorded in the product claim card C includes at least a dispensing permission indication for permitting dispensing of a product stored in one of the product storage devices 4. In this embodiment, this dispensing permission indication is represented by an item identifier for identifying an item to be dispensed (to be purchased). Different item identifiers are predefined for different items, and the item to be dispensed is determined when a user conveys an intention to purchase the item to the clerk at a counter or the like of a store such as a convenience store. As the item identifiers, different beverage numbers DN are assigned to different items, for example. Specifically, in this embodiment, in which five items of products are stored in the product storage devices 4, products of an item assigned with the beverage number DN of 1 are stored in the product storage columns 4a assigned with the column number CN of 1, for example. Similarly, products of items assigned with the beverage number DN of 2 to 5 are stored in the product storage columns 4a assigned with the column number CN of 2 to 5, respectively.

In addition, in this embodiment, the information recorded in each product claim card C includes a medium identifier unique to the product claim card C (referred to as “card identifier” below). In other words, the product claim card C previously records its card identifier and an item identifier (dispensing permission indication) as the information.

Each card identifier, which is unique to a product claim card C, is made, for example, of a number with appropriate digits. Each card identifier is set (numbered) so as to duplicate none of the card identifiers of product claim cards C used in another automatic product dispensing machine 100 of the same type that is installed in the same store. Furthermore, each card identifier is set (numbered) so as to duplicate none of the card identifiers of product claim cards C used in another automatic product dispensing machine 100 of the same type that is installed in another store. For example, the card identifiers of products of the same item (i.e., products with the same beverage number DN) are sequentially numbered in consideration of the maximum number of products that can be stored in each product storage column 4a.

For example, assume that each product storage column 4a is capable of storing up to 30 products therein. Then, the card identifiers corresponding to the beverage number DN of 1 are 001 to 030, the card identifiers corresponding to the beverage number DN of 2 are 031 to 060, the card identifiers corresponding to the beverage number DN of 3 are 061 to 090, the card identifiers corresponding to the beverage number DN of 4 are 091 to 120, and the card identifiers corresponding to the beverage number DN of 5 are 121 to 150. Here, as an example, assume also that each of the five product storage columns 4a of each product storage device 4 (41, 42) stores therein its maximum number of products (30 products). In other words, assume that each of the first storage device 41 and the second storage device 42 stores 150 products (300 products in total). Here, in this embodiment, among the first storage device 41 and the second storage device 42, only either one that is set as the dispensing-activated device actually dispenses products at a certain time, as described above. Thus, in this case, 150 products in total are actually ready for dispensing according to the user's request. Accordingly, in this embodiment, rather than 300 different card identifiers corresponding to 300 products, 150 different card identifiers (i.e., 001 to 150) corresponding to 150 products that are actually ready for dispensing at a time are issued. In other words, there are issued as many card identifiers as the maximum number of the products that the automatic product dispensing machine 100 is ready to dispense at a time.

The user conveys an intention to purchase an item to the clerk at the counter or the like of the store such as a convenience store, and makes a payment for the price of the item by a desired payment method (form) such as cash (coins and/or bills), electronic money card, credit card, prepaid card, or debit card. When completing the payment, the user receives, from the clerk, a product claim card C that records its card identifier and the item identifier of this item. In this way, by face-to-face communication with the clerk rather than interaction with the machine, the user selects an item that the user wishes to purchase and makes a payment for the item, and obtains a relevant product claim card C in exchange. Thus, when, for example, the user wishes to additionally purchase another item displayed on a product shelf or the like in the store, the user may make payments for this additional item and for the item stored in the automatic product dispensing machine 100 at a time by a desired payment method (form). Also, even when the user is an elderly person or a foreigner who is unfamiliar with machine operations, the clerk may help the user select a desired item from the items stored in the automatic product dispensing machine 100 and make a payment for the selected item so as to facilitate the purchasing procedure, for example.

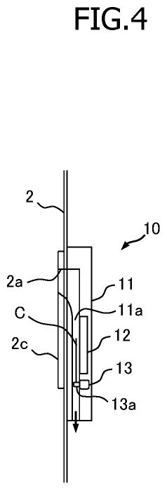

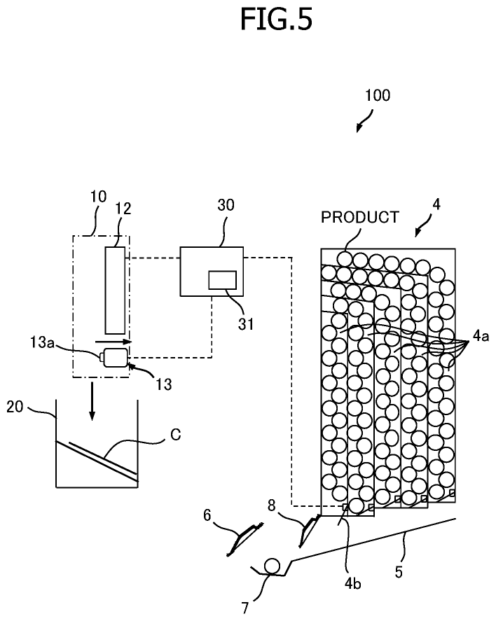

Next, the card reader unit 10, the collecting part 20, and the control unit 30 will be described in detail with reference to FIGS. 1 to 5. FIG. 4 is a cross-sectional view of a substantial part including the card reader unit 10 as viewed in the direction of arrow A-A of FIG. 1. FIG. 5 is a schematic diagram for illustrating the operation of the automatic product dispensing machine 100. The card reader unit 10 is for reading information from each product claim card C and includes a main body 11, a reading unit 12, and a card lock part 13.

The main body 11 is mounted on the back surface of the outer door 2 so as to cover the insertion slot 2a from the back side of the outer door 2. The main body 11 has a slit portion 11a formed so as to extend in the vertical direction. The slit portion 11a guides downward the product claim card C inserted (put) through the insertion slot 2a by the user. One end of the slit portion 11a communicates with the insertion slot 2a and the other end opens downward.

The reading unit 12 is mounted to the main body 11 so as to face the slit portion 11a. The reading unit 12 reads (in a contactless manner, for example) the information as described above from the product claim card C while it passes through the slit portion 11a. The reading unit 12 outputs the read information (item identifier and card identifier) to, for example, the control unit 30.

The card lock part 13, which is disposed below the reading unit 12, is for preventing the coming off of (for locking) the inserted product claim card C, and includes, for example, a protrudable portion 13a which can be made to protrude and to retract in the front-back direction. For example, in the initial state (i.e., when the product claim card C is inserted), the card lock part 13 extends (protrudes) the protrudable portion 13a into the slit portion 11a so that the lower end of the product claim card C abuts on the protrudable portion 13a. As a result, the card lock part 13 stops the product claim card C in front of the reading unit 12 in the slit portion 11a, and has the reading unit 12 reliably read the information stored in the product claim card C. The control unit 30 controls the operation of the card lock part 13. The reading unit 12 and card lock part 13 are disposed at positions that ensure, when the protrudable portion 13a is extended so as to appropriately position the product claim card C, the upper end of the product claim card C is located sufficiently lower than the insertion slot 2a.

The collecting part 20 is a box for collecting and containing the product claim card C after the reading unit 12 has read the information recorded in the product claim card C. For example, the collecting part 20 has an open top and is disposed below the card reader unit 10 so as to collect the product claim card C coming off through the slit portion 11a of the card reader unit 10. When the dispensing-activated device setting and under-preparation device setting of the product storage devices 4 are switched with each other (i.e., at the time of product restocking by the operator or the like), the operator or the like collects used product claim cards C contained in the collecting part 20. These used and collected product claim cards C will be reused in the same product automatic dispensing machine 100 as the product claim cards C for the upcoming dispensing-activated device, together with the product claim cards C of which payment has not been made (unused product claim cards C) which are left in the counter or the like of the same store. Each product claim card C may be reused as it is without rewriting of the information therein. In other words, each product claim card C that records the card identifier and beverage number DN is reused without change in the same automatic product dispensing machine 100 in the same store.

The control unit 30, which is provided on the back surface of the outer door 2, controls the overall operation of the automatic product dispensing machine 100, for example. The control unit 30 controls the operation of the cooling device, as described above. Furthermore, the control unit 30 also controls the switching of the dispensing-activated device setting and under-preparation device setting of the product storage devices 4, the product dispensing operation of the product storage device 4 (product dispensing mechanisms 4b, more specifically) that is set as the dispensing-activated device, and the operation of the card lock part 13. The control unit 30 includes a storage unit 31 for previously storing appropriate information therein.

The storage unit 31 previously stores therein the card identifiers (medium identifiers) of the product claim cards C which are expected to be used (i.e., expected to be issued (numbered) in the store). In this embodiment, each card identifier is associated with the corresponding beverage number DN in the storage unit 31. Furthermore, in this embodiment, each beverage number DN is associated with a column number CN in the storage unit 31 so as to identify which item of products are stored in the product storage columns 4a assigned with one of the column numbers CN (=1 to 5). In other words, the storage unit 31 previously stores therein the card identifiers, the beverage numbers DN, and the column numbers CN in association with each other.

Next, how the switching of the aforementioned settings and the product dispensing operation are controlled by the control unit 30 will be described in detail.

The control unit 30 sets one of the product storage devices 4 (41, 42) as the dispensing-activated device which is ready to dispense the products, and sets the other as the under-preparation device which is forced to stop dispensing the products. In addition, the control unit 30 switches the dispensing-activated device setting and under-preparation device setting of the product storage devices 4 (41, 42) with each other at predetermined time intervals. For example, the control unit 30 performs control so that the dispensing-activated device setting and under-preparation device setting of the product storage devices 4 (41, 42) are automatically switched with each other every 24 hours using a built-in timer. Immediately before such switching, the product stock level in the dispensing-activated device (41 or 42) becomes low, and the under-preparation device (42 or 41) becomes ready to dispense the supercooled products. The operator or the like restocks the new under-preparation device (41 or 42) with products immediately after such switching, for example.

Furthermore, in accordance with the information read by the reading unit 12, the control unit 30 outputs a dispensing permission command to one of the product dispensing mechanisms 4b for permitting dispensing a product. Specifically, when the reading unit 12 outputs the read information to the control unit 30, the control unit 30 outputs the dispensing permission command to the product dispensing mechanism 4b of a particular one of the product storage columns 4a. Here, this particular product storage column 4a is included in the product storage device 4 (41 or 42) that is set as the dispensing-activated device and is assigned with the column number CN corresponding to the beverage number DN included in the read information.

In addition, in this embodiment, when the control unit 30 has output a dispensing permission command to one of the product dispensing mechanisms 4b in accordance with the information read by the reading unit 12, the control unit 30 stores, into the storage unit 31, a dispensing completion indication that indicates the completion of the dispensing of the relevant product. Specifically, the dispensing completion indication is stored in the storage unit 31 in association with the card identifier that is stored in the storage unit 31 and that matches the card identifier included in the information read by the reading unit 12.

Furthermore, in this embodiment, all the dispensing completion indications stored in the storage unit 31 are capable of being erased at predetermined time intervals. It is expected that, after being used, each product claim card C will be reused as it is in the same automatic product dispensing machine 100 in the same store. To allow this, the control unit 30 erases only the dispensing completion indications from the data stored in the storage unit 31 either at the same time as the switching of the dispensing-activated device setting and under-preparation device setting of the product storage devices 4 or at a time point delayed by a preset time from such switching, for example. Here, the preset time is determined according to the amount of time required of the operator or the like to complete product restocking. When erasing the dispensing completion indications, the control unit 30 does not erase the card identifiers stored in the storage unit 31 in association with the beverage numbers DN so that the storage unit 31 continues to store therein these card identifiers.

Here, there are needs to prevent fraud such as unauthorized product dispensing with the use of an unauthorized product claim card C or an unauthorized copy of a properly obtained, authorized product claim card C. To meet such needs, the automatic product dispensing machine 100 according to this embodiment prepares for these types of fraud, as described in detail below.

For example, someone may commit fraud with the use of a product claim card C that records a card identifier of an unauthorized number. To prevent such fraud, the control unit 30 determines whether the inserted product claim card C is unauthorized or not by checking whether or not the card identifier included in the information that is read by the reading unit 12 matches any one of the card identifiers stored in the storage unit 31. Specifically, when the card identifier included in the information that is read by the reading unit 12 matches any one of the card identifiers stored in the storage unit 31, the control unit 30 outputs a dispensing permission command and also outputs, to the card lock part 13, a command to retract the protrudable portion 13a. As a result, the product claim card C comes off down through the slit portion 11a and is contained in the collecting part 20. On the other hand, when the card identifier included in the information that is read by the reading unit 12 matches none of the card identifiers stored in the storage unit 31, the control unit 30 maintains the protrudable portion 13a in the extended (protruding) state and holds the product claim card C in the slit portion 11a. In addition, the control unit 30 lets the clerk know that the inserted product claim card C may be an unauthorized card or the like by, for example, turning on an indicator lamp (not shown).

Also, someone may commit a fraud by causing the automatic product dispensing machine 100 to dispense multiple products with the use of a single product claim card C that records a card identifier of an authorized number. To prevent such fraud, only when the card identifier included in the information that is read by the reading unit 12 matches any one of the card identifiers stored in the storage unit 31 and the dispensing completion indication that is associated with this matched card identifier is not stored in the storage unit 31, the control unit 30 outputs a dispensing permission command and also outputs, to the card lock part 13, a command to retract the protrudable portion 13a. As a result, the product claim card C comes off down through the slit portion 11a and is contained in the collecting part 20. On the other hand, when the card identifier included in the information that is read by the reading unit 12 matches any one of the card identifiers stored in the storage unit 31 and the dispensing completion indication that is associated with this matched card identifier is already stored in the storage unit 31, the control unit 30 does not output a dispensing permission command. In this case, the control unit 30 maintains the protrudable portion 13a in the extended state and turns on the indicator lamp.

There is also a need to prevent fraud with the use of an unauthorized copy of a properly obtained, authorized product claim card C. When such fraud is committed, there would be some time between when the authorized product claim card C is obtained at the store and its unauthorized copy is used in the store. In consideration this, to prevent such fraud, the control unit 30 may invalidate a particular one (as described below) of the card identifiers previously stored in the storage unit 31 and does not output a dispensing permission command when this invalidated card identifier is read. In this case as well, the control unit 30 maintains the protrudable portion 13a in the extended state and turns on the indicator lamp. Here, when payment for a product claim card C has been made at the counter or the like of the store, a dispensing completion indication associated with the card identifier of the product claim card C is expected to be stored in the storage unit 31 a few moments later. Thus, the control unit 30 may be manually configured to invalidate the card identifier of a paid product claim card C when the dispensing completion indication associated with the card identifier of this paid product claim card C is not stored in the storage unit 31 at, for example, the time of product restocking.

Next, the operation of the automatic product dispensing machine 100 according to this embodiment from reading of the information to dispending a product will be described with reference to FIGS. 3 to 5. In the following description, it is assumed that none of the aforementioned types of fraud is committed.

When the user inserts a product claim card C through the insertion slot 2a, the slit portion 11 a guides the product claim card C toward the reading unit 12. In this initial state, the card lock part 13 extends (protrudes) the protrudable portion 13a into the slit portion 11a so as to stop the product claim card C in front of the reading unit 12 in the slit portion 11a, as shown in FIGS. 3 and 4. Then, the reading unit 12 reads the information recorded in the product claim card C and outputs the read information to the control unit 30. The control unit 30 checks and determines (by computation) that the card identifier included in the information that is read by the reading unit 12 matches any one of the card identifiers stored in the storage unit 31, that the dispensing completion indication associated with this matched card identifier is not stored in the storage unit 31, and that this card identifier is not invalidated. Then, the control unit 30 outputs a dispensing permission command to the product dispensing mechanism 4b of the product storage column 4a that is included in the product storage device 4 (41 or 42) being set as the dispensing-activated device and that is assigned with the column number CN corresponding to the beverage number DN included in the read information. When the dispensing permission command is output to the product dispensing mechanism 4b, the product dispensing mechanism 4b pivots to a dispensing position as shown in FIG. 5 and drops down a product positioned at the lowest from the corresponding product storage column 4a. The product rolls on the slope of the product shooter 5, then pushes open the inner-door flap 8 attached to the product dispensing opening 3a, and is dispensed into the product receiving portion 7. After that, the user opens the outer-door flap 6 and receives the product in the product receiving portion 7.

In the automatic product dispensing machine 100 according to this embodiment, the reading unit 12 reads the information including at least a dispensing permission indication of a product from a product claim card C that records the information, the collecting part 20 collects the product claim card C after the reading unit 12 has read the information, and the control unit 30 outputs a dispensing permission command to one of the product storage devices 4 for permitting dispensing a product in accordance with the information read by the reading unit 12. This allows the user to receive the product dispensed by the product storage device 4 simply by having the reading unit 12 read the information of the product claim card C. In addition, since the product claim card C is collected by the collecting part 20 rather than being returned to the user, the user does not feel annoyed by the manner of handling and managing the product claim card C after use. As described above, instead of requiring conventional operations and the like such as inputting money such as coins into the machine, pressing an item selection button, and receiving change, the automatic product dispensing machine 100 only requires the user to perform a simple operation of having the machine read the information of the product claim card C in order to receive a product. The present invention provides the automatic product dispensing machine 100 that allows the user to easily receive a product by performing fewer operations on the machine.

Furthermore, used product claim cards C contained in the collecting part 20 may be collected by the operator or the like and easily reused.

In this embodiment, each product storage device 4 is capable of storing multiple items of products therein, and each dispensing permission indication is represented by an item identifier for identifying an item to be dispensed. Thus, in the automatic product dispensing machine capable of dispensing multiple items of products as in this embodiment, the dispensing permission indication may be transmitted by the reading unit 12 to the control unit 30 not only as an indication to permit product dispensing, but also as information that specifies an item to be dispensed.

Also, in this embodiment, each product claim card C previously stores therein a card identifier. This makes the card identifier beneficial for use in preventing fraud involving the product claim card C.

In addition, in this embodiment, there are issued as many card identifiers as the maximum number of the products that the automatic product dispensing machine 100 is ready to dispense at a time. This means that there are issued as many product claim cards C as the maximum number of the products that are ready to be dispensed at a time. Thus, the clerk or the like may visually grasp how many products of each item are left ready for sale at the store simply by counting the product claim cards C left in the counter or the like of the store or counting the product claim cards C contained in the collecting part 20.

Furthermore, the automatic product dispensing machine 100 according to this embodiment further includes the storage unit 31 for previously storing therein the card identifiers of the product claim cards C which are expected to be used. When the control unit 30 has output a dispensing permission command in accordance with the information read by the reading unit 12, the control unit 30 stores, into the storage unit 31, a dispensing completion indication in association with the card identifier that is stored in the storage unit 31 and that matches the card identifier included in the information read by the reading unit 12. This dispensing completion indication allows for checking whether the user has actually received the relevant product after obtaining the product claim card C, and facilitates managing how many products have been dispensed and how many products are left stored. Note that a time stamp indicating when a product is dispensed may be added to each dispensing completion indication. This allows for more detailed management of the machine's dispensing history.

Furthermore, according to this embodiment, all the dispensing completion indications stored in the storage unit 31 are capable of being erased at predetermined time intervals. Here, while the dispensing completion indication for a product claim card C is stored in the storage unit 31, the product claim card C is recognized as a used card. Accordingly, such erasure means that, under the control of the control unit 30, the product claim card C is reset to be recognized as an unused card. This allows the product claim card C to be reused as it is without the need for erasing the card identifiers stored in the storage unit 31 and allows the storage unit 31 to continue to store therein these card identifiers.

In this embodiment, the control unit 30 determines whether an inserted product claim card C is unauthorized or not by checking whether or not the card identifier included in the information that is read by the reading unit 12 matches any one of the card identifiers stored in the storage unit 31. Thus, a fraud with the use of a product claim card C that records a card identifier of an unauthorized number may be prevented by a simple method using the card identifier.

Furthermore, in this embodiment, when the card identifier included in the information that is read by the reading unit 12 matches any one of the card identifiers stored in the storage unit 31 and the dispensing completion indication that is associated with this matched card identifier is not stored in the storage unit 31, the control unit 30 outputs a dispensing permission command. On the other hand, when the dispensing completion indication that is associated with this matched card identifier is already stored in the storage unit 31, the control unit 30 does not output a dispensing permission command. Thus, even if someone fraudulently attempts to pull out a product claim card C that records a card identifier of an authorized number from the automatic product dispensing machine 100 after using the product claim card C to cause the machine to dispense a relevant product, and then to use this same product claim card C to additionally cause the machine to dispense another product, such fraud may be prevented by a simple method using the card identifier.

In this embodiment, each card identifier, which is unique to a product claim card C, is set (numbered) so as to not only duplicate none of the card identifiers of product claim cards C used in another automatic product dispensing machine 100 of the same type that is installed in the same store, but also duplicate none of the card identifiers used in another automatic product dispensing machine 100 of the same type that is installed in another store. Thus, even if someone fraudulently attempts, for example, to cause multiple automatic product dispensing machines 100 of the same type that are installed in the same store or different stores to dispense multiple products with the use of a single product claim card C, such fraud may be prevented by a simple method using the card identifier.

In this embodiment, the control unit 30 invalidates a particular one of the card identifiers previously stored in the storage unit 31 and does not output a dispensing permission command when this invalidated card identifier is read. Thus, fraud with the use of an unauthorized copy of a properly obtained product claim card C may be prevented by a simple method using the card identifier.

In the above description, the storage unit 31 is included in the control unit 30. However, this is merely illustrative and the present invention is not limited to this. Alternatively, the storage unit 31 may be included in the card reader unit 10, or may be provided separately from the control unit 30 and card reader unit 10. Also, the reading unit 12 may be provided with a function to write data to the product claim card C. This provides the automatic product dispensing machine 100 with capability to appropriately rewrite data in the product claim card C and additionally write appropriate data to the product claim card C.

In the above description, each product claim card C is an IC card incorporating an IC chip that records the aforementioned information. However, the present invention is not limited to this. Alternatively, any appropriate recording medium may be used as the product claim card C. Examples of appropriate recording mediums include a magnetic card that records this information and a card which is made of a suitable material such as paper and on which a barcode indicating this information is printed (recorded).

In the above embodiment, the item identifiers are simply represented by the single-digit beverage numbers DN (1 to 5). However, the present invention is not limited to this. Alternatively, any appropriate identifiers, such as Japanese Article Number (JAN) numbers, may be used as the item identifiers. Also, although each dispensing permission indication is represented by one of the item identifiers in the above embodiment, the present invention is not limited to this. Alternatively, each dispensing permission indication may be represented by one of the column numbers CN that stores therein products of the relevant item. Furthermore, the dispensing permission indication does not have to be represented by the item identifier or column number CN. For example, when the automatic product dispensing machine 100 stores therein a single product item, there is no need to communicate, to the control unit 30, which item to dispense or which of the product storage columns 4a stores products of this item therein. Thus, in such a case, the dispensing permission indication has only to indicate dispensing permission in a predetermined recognizable form.

In the above embodiment, the automatic product dispensing machine 100 prevents fraud as described above mainly by data management control using the card identifiers. Additionally, for example, the automatic product dispensing machine 100 may include a pull-out prevention mechanism for preventing the pulling out of a product claim card C that has already been inserted in, as needed. Such a pull-out prevention mechanism may be provided above the reading unit 12 or the like.

In the above embodiment, the automatic product dispensing machine 100 stores and dispenses supercooled beverages as the products. However, the present invention is not limited to this. Alternatively, the automatic product dispensing machine 100 may be configured to store and dispense products such as hot beverages or normal cold beverages maintained at a preset temperature having a wider allowable range than that for supercooled beverages. In this case, both the first storage device 41 and the second storage device 42 may be set as the dispensing-activated device all the time. Furthermore, the products stored and dispensed by the automatic product dispensing machine 100 are not limited to bottled beverages, but may be any other appropriate products.

In the above embodiment, the automatic product dispensing machine 100 is configured to dispense a product to the user in exchange for the product claim card C rather than in exchange for money paid through interaction with the machine. Thus, unlike a conventional vending machine, the automatic product dispensing machine 100 according to the embodiment includes no money transaction device including item selection buttons, a coin slot, and a bill slot. However, the present invention is not limited to this, and the automatic product dispensing machine 100 may include such a money transaction device. For example, the automatic product dispensing machine 100 may be configured to dispense a product of a best-selling item to an elderly person or a foreigner who is unfamiliar with machine operations in exchange for a product claim card C. Additionally or alternatively, the automatic product dispensing machine 100 may be configured to require, when the user wishes to purchase an item other than the best-selling item or whenever the user wishes to purchase an item stored in the automatic product dispensing machine 100, the user to select this desired item using the item selection button, and configured to dispense a product of the selected item in exchange for money paid using the money transaction device as the conventional vending machine is.

The present invention has been specifically described above with reference to the preferred embodiment and its modifications. It is clear that one skilled in the art could conceive of various modified embodiments based on the essential technical concept and the teachings of the present invention.

### REFERENCE SYMBOL LIST

4 Product storage device

12 Reading unit

20 Collecting part

30 Control unit

31 Storage unit

100 Automatic product dispensing machine

C Product claim card (recording medium)

1. An automatic product dispensing machine comprising a product storage device for storing products therein and sequentially dispensing the stored products, and a control unit for controlling product dispensing operation of the product storage device, the automatic product dispensing machine further comprising:
a reading unit for reading information including at least a dispensing permission indication of one of the products from a recording medium that records the information; and
a collecting part for collecting and containing the recording medium after the reading unit has read the information,
wherein, in accordance with the information read by the reading unit, the control unit outputs a dispensing permission command to the product storage device for permitting dispensing of the product.

2. The automatic product dispensing machine according to claim 1, wherein
the product storage device is capable of storing a plurality of items of products therein, and
the dispensing permission indication included in the information is represented by an item identifier for identifying an item to be dispensed.

3. The automatic product dispensing machine according to claim 1, wherein the information includes a medium identifier unique to the recording medium.

4. The automatic product dispensing machine according to claim 3, further comprising:
a storage unit for previously storing therein a plurality of the medium identifiers of a plurality of the recording mediums which are expected to be used,
wherein, when the control unit has output the dispensing permission command in accordance with the information read by the reading unit, the control unit stores, into the storage unit, a dispensing completion indication in association with a medium identifier that is stored in the storage unit and that matches the medium identifier included in the information read by the reading unit, the dispensing completion indication indicating completion of dispensing of the product.

5. The automatic product dispensing machine according to claim 4, wherein all dispensing completion indications stored in the storage unit are capable of being erased at predetermined time intervals.

6. The automatic product dispensing machine according to claim 4, wherein
when the medium identifier included in the information that is read by the reading unit matches any one of the medium identifiers stored in the storage unit and the dispensing completion indication that is associated with this matched medium identifier is not stored in the storage unit, the control unit outputs the dispensing permission command, and
when the dispensing completion indication that is associated with this matched medium identifier is already stored in the storage unit, the control unit does not output the dispensing permission command.

7. The automatic product dispensing machine according to claim 4, wherein the control unit invalidates a particular one of the plurality of medium identifiers previously stored in the storage unit, and does not output the dispensing permission command when this invalidated card identifier is read.
